(19) United States
(12) Patent Application Publication
(10) Pub. No.: US 2021/0109509 A1
(43) Pub. Date: Apr. 15, 2021

(54) SYSTEM FOR PERFORMING DYNAMIC PRODUCTION AND MATERIAL TRANSPORTATION MANAGEMENT IN FACTORY AREA

(71) Applicant: Wholeknit International Co., Ltd., Apia (WS)

(72) Inventor: Chih-Wen LIAO, Taichung (TW)

(21) Appl. No.: 17/028,134

(22) Filed: Sep. 22, 2020

(30) Foreign Application Priority Data
Oct. 15, 2019 (TW) 108136984

(51) Int. Cl. G05B 19/418; G06Q 10/08

(52) U.S. Cl. CPC G05B 19/41865; G06Q 10/087; G05B 19/41885; G05B 19/4183

(57) ABSTRACT

The invention provides a system for performing production and factory area material transportation management, comprising a production demand management unit, a warehouse management unit, an advanced scheduling management unit, a manufacturing execution unit and a transport dispatching unit. The production demand management unit receives at least one production demand data input externally. The warehouse management unit records a plurality of production material storage data. The advanced scheduling management unit outputs at least one production scheduling data based on the at least one production demand data and working states of a plurality of operation areas. The manufacturing execution unit generates at least one production execution data based on the production scheduling data. The transport dispatching unit controls a plurality of porter robots based on the production execution data, and controls the plurality of porter robots for continued transfer again when the same processing data is marked to be completed.

### FIELD OF THE INVENTION

The invention relates to a management system, in particular to a system for performing dynamic production and factory area material transportation management.

### BACKGROUND OF THE INVENTION

Generally, when materials are transported in a factory, goods are directly carried by manpower or a transporting vehicle is controlled by the manpower so as to facilitate collection and transportation of the materials, and once the manpower of the factory is insufficient, it causes that the materials may not be transported. Conventionally, when transporting and collecting materials by manpower, a worker carries the materials to one of shelves in a work zone. If the worker does not explicitly record the storage position of the materials, a subsequent worker needs to spend more time searching the materials, so that the time required for goods delivery is prolonged. Meanwhile, due to the fact that the time for finding material is prolonged, part of machines in the factory area are idle due to the fact that the materials are not obtained, and the processing output value of the machines cannot be improved. In addition, the factory usually performs material checking operations manually in the past. Once the checking personnel make mistakes in checking or careless omissions in recording, the situation that the materials are repeatedly purchased or not purchased can be generated. The factory loss can be caused by repeated ordering if accumulated materials in the factory are purchased far more than the materials required by the manufacturing process, and the delivery date can be delayed if the materials are not purchased.

On the other hand, due to the fact that the processing time of each machine generally cannot be accurately estimated in a factory, and the finishing processes performed by each machine are different, some machines may be idle due to the fact that the time required by the processing is short and the operation is completed earlier when the factory builds to order. Therefore, the idle machines cannot perform another processing operation earlier, so that the machines are continuously idle, and there is a problem of wasting capacity.

### SUMMARY OF THE INVENTION

The present invention has a primary object to solve the problems deriving from manual transport and material checking in a factory in the past.

The invention has a secondary object to solve the problems that a part of machines are idle and the capacity is wasted due to the fact that the processing time required by machines cannot be accurately estimated in the factory in the past.

To achieve the above objects, the present invention provides a system for performing dynamic production and factory area material transportation management. The system comprises a production demand management unit, a warehouse management unit, an advanced scheduling management unit, a manufacturing execution unit, and a transport dispatching unit. The production demand management unit receives at least one production demand data input externally. The warehouse management unit is connected with the production demand management unit, and records a plurality of production material storage data which respectively comprise a name information, a position information and a quantity information. The advanced scheduling management unit is connected with the production demand management unit and receives the at least one production demand data, and the advanced scheduling management unit outputs at least one production scheduling data based on the at least one production demand data and working states of a plurality of operation areas in the factory area. The manufacturing execution unit is connected with the advanced scheduling management unit and receives the at least one production scheduling data, and the manufacturing execution unit generates at least one production execution data based on the at least one production scheduling data, and the at least one production execution data comprises a plurality of processing data and a plurality of material data respectively corresponding to one of the plurality of processing data. The transport dispatching unit is connected with the manufacturing execution unit and the warehouse management unit, and the transport dispatching unit controls at least one of a plurality of porter robots based on one of the plurality of processing data to transport the production material based on one of the plurality of material data to the one of the operation areas correspondingly, wherein after the one of the plurality of processing data is marked, the transport dispatching unit further controls at least one of a plurality of porter robots to transport semi-finished products made by the marked processing data to the next operation area according to another one of the plurality of processing data subsequent to the marked processing data.

In an embodiment, the system further comprises an electronic purchasing unit connected with the production demand management unit, the production demand management unit generates a purchasing data according to the at least one production demand data and the plurality of production material storage data, and the production demand management unit sends the purchasing data to the electronic purchasing unit to cause the electronic purchasing unit to send a purchasing notice to at least one supply end.

In an embodiment, the plurality of operation areas comprises a raw material factory-entry inspection area and a raw material storage area, the transport dispatching unit is connected with at least one portable electronic device held by a worker, and the transport dispatching unit controls at least one of the plurality of porter robots to transport raw materials from the raw material factory-entry inspection area based on an warehouse-entry transport request sent by the portable electronic device, and the warehouse management unit updates and adjusts at least one of the plurality of production material storage data based on a warehouse-entry information transmitted by the portable electronic device when the transport dispatching unit controls the at least one of the plurality of porter robots to transport the production materials to the raw material storage area.

In an embodiment, the raw material factory-entry inspection area comprises a goods receiving sub-area and a weighing sub-area.

In an embodiment, the production demand management unit receives at least one goods delivery data input externally and sends a goods-delivery transport notice data to the warehouse management unit based on the goods delivery data, and the warehouse management unit requests the transport dispatching unit to control at least one of the plurality of porter robots to move to one of the operation areas where finished products are stored according to the goods-delivery transport notice data.

In an embodiment, the transport dispatching unit is connected with at least one auxiliary transporting device in the factory area, and the transport dispatching unit controls the auxiliary transporting device according to a transport route of one of the plurality of porter robots.

In an embodiment, the auxiliary transporting device is selected from the group consisting of a lifting device, a conveyor belt, or a mechanical arm.

In an embodiment, the transport dispatching unit defines portable areas of the plurality of porter robots based on the plurality of operation areas.

In an embodiment, the transport dispatching unit records a plurality of location points of the factory area, and the transport dispatching unit controls the plurality of porter robots based on the plurality of location points of the factory area.

In an embodiment, the transport dispatching unit is connected with at least one portable electronic device held by a worker, and the transport dispatching unit controls at least one of the plurality of porter robots to move r based on a designated transport request sent by the portable electronic device.

In an embodiment, the plurality of operation areas is a batching area, a machining material buffer area, a semi-finished product buffer area, a quality inspection buffer area, a finished product storage area and a to-be-delivered area, respectively.

According to the foregoing disclosure and compared with the prior art, the invention has the following characteristics. According to the invention, the transport dispatching unit dispatches the plurality of porter robots based on the processing data, so that the plurality of porter robots can transport the production materials required to the designated operation area, and compared with the prior art, the transport dispatching unit can reduce the problems caused by manual transport of the materials, and can also reduce the idle condition of machines.

### BRIEF DESCRIPTION OF THE DRAWINGS

FIG. 1 is a schematic view of system units of a first embodiment of the invention.

FIG. 2 is a schematic view of a porter robot route in a processing state of the invention.

FIG. 3 is a schematic view of the portable area of the porter robot of the present invention.

FIG. 4 is a schematic view of the system units of a second embodiment of the invention.

FIG. 5 is a schematic view of the porter robot in a weighing qualified state.

FIG. 6 is a schematic view of a returned goods state of the porter robot of the invention.

FIG. 7 is a schematic view of the system units of a third embodiment of the invention.

FIG. 8 is a schematic view of the porter robot matched with an auxiliary transporting device.

FIG. 9 is a schematic view of the system units of a fourth embodiment of the invention.

FIG. 10 is a schematic view of the system units of a fifth embodiment of the invention.

### DETAILED DESCRIPTION OF THE PREFERRED EMBODIMENTS

The detailed description and technical contents of the present invention will now be described with reference to the drawings as follows.

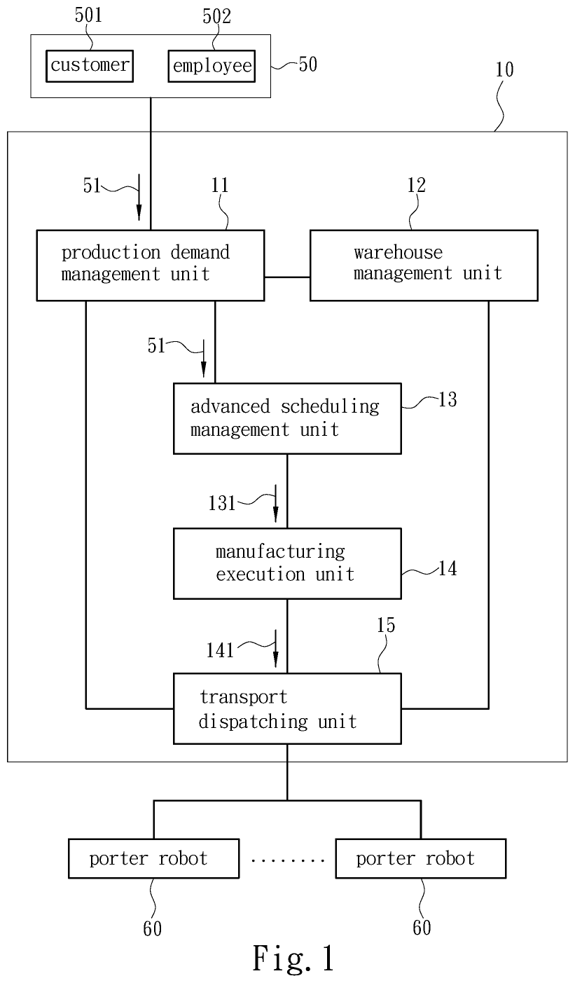

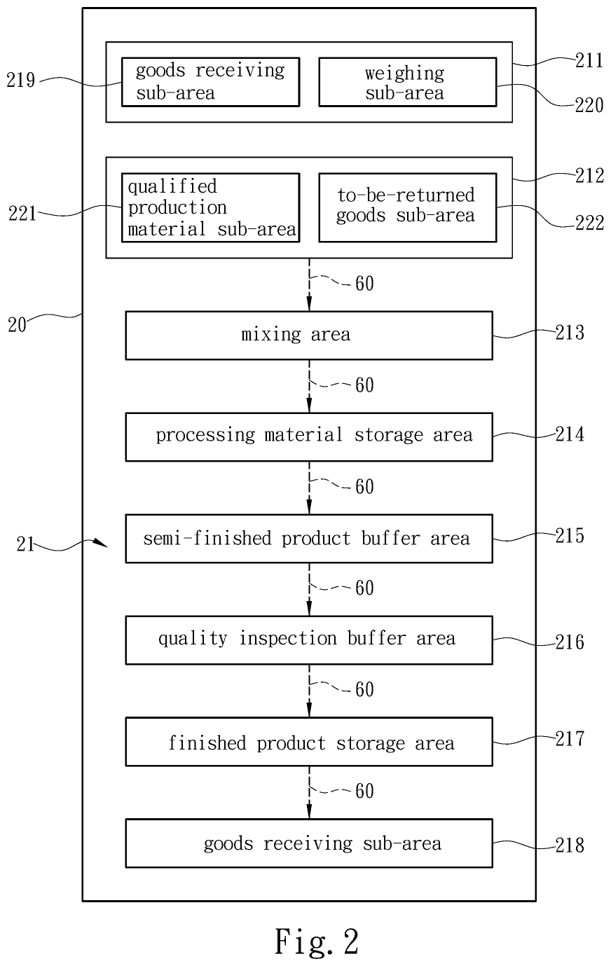

Referring to FIG. 1 and FIG. 2, the present invention provides a system 10 for performing dynamic production and material transportation management in factory area. The system 10 may be used for facilitating material transportation management in a factory area 20. The system 10 comprises a production demand management unit 11, a warehouse management unit 12, an advanced scheduling management unit 13, a manufacturing execution unit 14, and a transport dispatching unit 15. Further, the production demand management unit 11, the warehouse management unit 12, the advanced scheduling management unit 13, the manufacturing execution unit 14 and the transport dispatching unit 15 are components in a computer device respectively. The system 10 of the present invention may also add different functional components according to the requirements of the factory area 20 during actual implementation, in addition to the production demand management unit 11, the warehouse management unit 12, the advanced scheduling management unit 13, the manufacturing execution unit 14 and the transport dispatching unit 15. Further, the production demand management unit 11 receives at least one production demand data 51 input from an external 50 when implementation, the external 50 referred to herein is a third party outside the system 10, such as at least one customer 501 or at least one employee 502. In other words, the customer 501 or the employee 502 operates the system 10 to present the at least one production demand data 51 to the production demand management unit 11. The warehouse management unit 12 is connected with the production demand management unit 11. The warehouse management unit 12 records a plurality of production material storage data which respectively comprise a name information, a quantity information and a position information of a production material; and the name information includes a product name of the production material, the quantity information is about a product quantity of the production material, and the position information refers to a location where the production materials is placed. Further, referring to FIG. 2, the location where the production material is placed referred herein is one of a plurality of operation areas 21 within the factory area 20, wherein the plurality of operation areas 21 includes a raw material factory-entry inspection area 211 for placing raw materials to be inspected upon entry into the factory, a raw material storage area 212 for placing the raw materials which are qualified, a mixing area 213 for mixing the raw materials to become the production materials, a processing material buffer area 214 for temporarily storing the production materials, a semi-finished product buffer area 215 for placing the semi-finished products made by the production materials, a quality inspection buffer area 216 for temporarily storing the semi-finished products to be inspected, a finished product storage area 217 for storing finished products, and a to-be-delivered area 218 for placing the finished products to be delivered. In detail, the raw material factory-entry area 211 comprises a goods receiving sub-area 219 where the raw materials are placed upon entry into the factory and a weighing sub-area 220 where raw materials are weighed and inspected. The raw material storage area 212 includes a qualified production material sub-area 221 for temporarily storing raw materials qualified after inspection and a to-be-returned goods sub-area 222 for temporarily storing raw materials unqualified after inspection. Assuming that two thousand pieces of cloth are transmitted into the goods receiving sub-area 219 in the factory area 20 to be weighed and inspected, and three thousand finished jogging shoes are placed in the finished product storage area 217, the warehouse management unit 12 will record that one of the name information is “cloth”, the quantity information is “2000”, and the position information is “the goods receiving sub-area 219”, while the warehouse management unit 12 also records the name information of the other of the production materials is “the finished jogging shoes”, the quantity information is “3000” and the position information is “the finished product storage area 217”.

Further, the advanced scheduling management unit 13 is connected with the production demand management unit 11 and receives the at least one production demand data 51 transmitted by the production demand management unit 11. The advanced scheduling management unit 13 generates at least one production scheduling data 131 based on each production demand data 51 and working states of the plurality of operation areas 21 in the factory area 20 to manage a working schedule for each of the plurality of operation areas 21. For example, assuming that a batch of production materials has to be mixed prior to machining, the advanced scheduling management unit 13 generates the production scheduling data 131 according to the working conditions of all machines in the mixing area 213, and the production scheduling data 131 provides a starting time, a processing required time and an ending time of the machines in the mixing area 213. In addition, the manufacturing execution unit 14 is connected with the advanced scheduling management unit 13 and performs manufacturing execution based on the working schedule managed by the production scheduling data 131 as well as generates at least one production execution data 141. The at least one production execution data 141 comprises a plurality of processing data, and a plurality of material data respectively corresponds to one of the plurality of processing data, wherein each of the plurality of processing data includes at least one process step, and each of the plurality of material data includes at least one production material data that the process step is required.

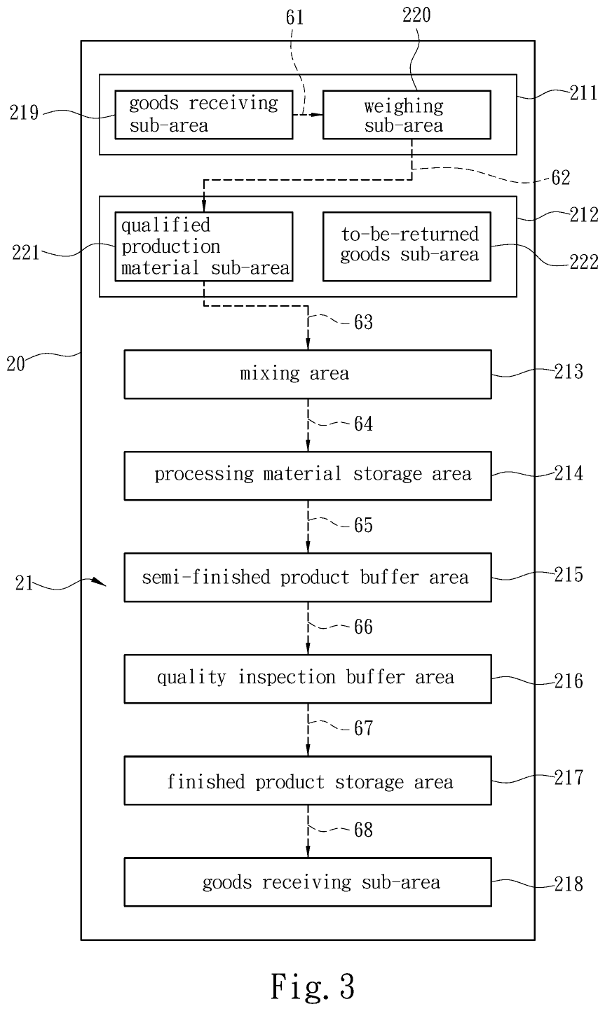

Further, the transport dispatching unit 15 is connected with the manufacturing execution unit 14 and the warehouse management unit 12. The transport dispatching unit 15 controls a plurality of porter robots 60 based on one of the plurality of processing data to enable the porter robots 60 transporting the production materials or the finished products to the designated operation area 21. For example, one of the plurality of processing data provides that the batch of production materials are produced by the process that raw materials are first removed from the raw material storage area 212 to be mixed and then machined. Accordingly, the transport dispatching unit 15 controls at least one of the porter robot 60 based on the above processing data to transport raw materials from the raw material storage area 212 to the mixing area 213 to be mixed; after the mixing is completed, the transport dispatching unit 15 controls the at least one of porter robot 60 to transport the mixed raw materials from the mixing area 213 to the processing material buffer area 214 to be machined. In an embodiment, the transport dispatching unit 15 controls the plurality of porter robots 60 to transport a plurality of identical production materials between the plurality of operation areas 21 for machining based on the plurality of processing data; additionally, the transport dispatching unit 15 further defines portable areas of the plurality of the porter robots 60 based on the plurality of operation areas 21. For example, referring to FIG. 3, in order to conveniently describe the portable areas of the plurality of porter robots 60 which are divided into a first porter robot 61, a second porter robot 62, a third porter robot 63, a fourth porter robot 64, a fifth porter robot 65, a sixth porter robot 66, a seventh porter robot 67, and an eighth porter robot 68. In practice, the transport dispatching unit 15 controls the first porter robot 61 to move back and forth between the goods receiving sub-area 219 and the weighing sub-area 220 for transporting the production materials to the weighing sub-area 220 and allowing the production materials being weighed. The second porter robot 62 moves back and forth between the weighing sub-area 220 and the qualified production material sub-area 221. The third porter robot 63 transports the production materials from the qualified production material sub-area 221 to the mixing area 213 for mixing. The fourth porter robot 64 moves back and forth between the mixing area 213 and the processing material buffer area 214 for transporting. The fifth porter robot 65 moves back and forth between the processing material buffer area 214 and the semi-finished product buffer area 215 for transporting. The sixth porter robot 66 transports the semi-finished products from the semi-finished product buffer area 215 to the quality inspection buffer area 216 to be inspected. The seventh porter robot 67 transports the finished product in the quality inspection buffer area 216 to the finished product storage area 217 for storage. The eighth porter robot 68 transports the finished products to be delivered from the finished product storage area 217 to the to-be-delivered area 218. Further, the portable areas of each of the plurality porter robots 60 can be adjusted according to practical requirements.

Also, in order for the transport dispatching unit 15 to fully control a transport route of each of the porter robots 60 between the plurality of operation areas 21, the factory area 20 is provided with a plurality of location points which are recorded by the transport dispatching unit 15. In implementation, the transport dispatching unit 15 controls each of the plurality of porter robots 60, based on the plurality of location points, to move on the transport route without interference problems such as collision. Further, the transport dispatching unit 15 also monitors a moving status of each of the plurality of porter robots 60 based on each of the location plurality of points. For example, the mixing area 213 and the processing material buffer area 214 are respectively provided with one of the plurality of location points. When the transport dispatching unit 15 intends to control one of the plurality of porter robots 60 to transport the production materials from the mixing area 213 to the processing material buffer area 214, one of the plurality of porter robots 60 controlled by the transport dispatching unit 15 first passes through one of the plurality of location points in the batching area 213 and then passes through the other one of the plurality of location point in the processing material buffer area 214. Once the controlled porter robot 60 has passed one of the plurality of location points in the mixing area 213 and has not reached the other one of the plurality of location points in the processing material buffer area 214 within a predetermined time, and the transport dispatching unit 15 notifies a employee 502 in the factory area 20 to sooner detect an abnormality of the controlled porter robots 60 since the transport route of the controlled porter robot 60 is not recorded, thereby reducing the time required for exception removal.

Next, referring to FIG. 1 and FIG. 2, an implementation of the system 10 of the present invention will now be described. First, assuming that the production demand management unit 11 receives the at least one production demand data 51 after receiving an order data submitted by a customer 501 or a employee 502, and a quantity of the production materials in the factory area 20 corresponding to the at least one production demand data 51 is satisfied, at this time, the warehouse management unit 12 stores a storage data of the production materials required for the order data, and the advanced scheduling management unit 13 outputs the at least one production scheduling data 131 based on the at least one production demand data 51 and the working conditions of the machines for processing and manufacturing in the plurality of operation areas 21, after receiving the at least one production demand data 51. Further, the manufacturing execution unit 14 generates the at least one production execution data 141 based on the at least one production scheduling data 131, so that the machines in the plurality of operation areas 21 perform manufacturing corresponding to the at least one production execution data 141 of the manufacturing execution unit 14, respectively. Then, when the transport dispatching unit 15 acquires one of the plurality of processing data, the transport dispatching unit 15 controls at least one of the plurality of porter robots 60 based on one of the plurality of processing data, and the at least one of the plurality of porter robots 60 acquires one of the plurality of material data and one of the plurality of production material storage data to transport the corresponding the production materials from a storage place to one of the plurality of operation areas 21 that a designated machine is located. When one of the plurality of processing data that afore mentioned is marked as completion, the transport dispatching unit 15 accesses the other one of the plurality of processing data subsequent to one of the processing data that afore mentioned, and at least one of the porter robots 60 is controlled to transport a semi-finished product made of the production material to the other one of the plurality of operation areas 21. In practice, the machines in one of the plurality of operation areas 21 perform the processing operations in different speeds, so that some of the machines may have completed the previous process and be idle. When the machines produce defective products during machining, the advanced scheduling management unit 13 then manages the idle machines to additionally produce products corresponding to the number of defective products. At the same time, the transport dispatching unit 15 controls at least one of the plurality of porter robots 60 to transport the production materials required to the idle machines, thereby achieving the purpose of dynamic production.

Accordingly, the warehouse management unit 12 of the invention records the storage data of the production materials, and the transport dispatching unit 15 controls the plurality of porter robots 60 to transport the production materials from the storage place, so that the factory area 20 applies the system 10 of the present invention to replace manpower by the plurality of porter robots 60 doing transportation and taking inventory of materials so that reducing the time wasted in comparison with conventional managements. In addition, when the system 10 of the present invention is implemented, the advanced scheduling management unit 13 generates the at least one production scheduling data 131 based on the working state of each of the plurality of operation areas 21, and the plurality of porter robots 60 transports the production materials according to each of the plurality of processing data, so that an idle time of each of the plurality of operation areas 21 in the factory area 20 of the present invention is reduced, so as to accomplishing the concept of dynamic production.

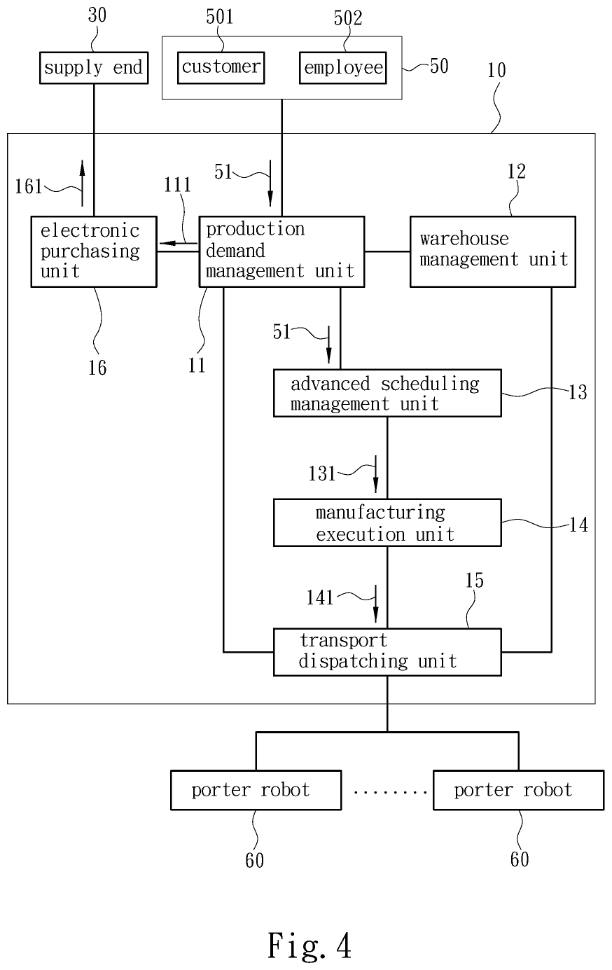

In an embodiment, referring to FIG. 4, the system 10 further comprises an electronic purchasing unit 16 connected with the production demand management unit 11. When the production demand management unit 11 receives the at least one production demand data 51, the production demand management unit 11 identifies the plurality of production material storage data based on the production materials required by the at least one production demand data 51. Once the production demand management unit 11 confirms that the quantity of production materials is insufficient, the production demand management unit 11 generates a purchasing data 111 based on the at least one production demand data 51. Further, the production demand management unit 11 sends the purchasing data 111 to the electronic purchasing unit 16, and the electronic purchasing unit 16 sends a purchasing notice 161 to at least one supply end 30 based on the purchasing data 111. Accordingly, the production demand management unit 11 of the present invention receives the at least one production demand data 51, and further confirms the quantity of the production materials. Compared with the prior art, the present invention does not need to confirm the quantity of the production materials by manpower, and also reduce conditions that a recording of the quantity of the production materials is wrong or a purchase order is not placed to the electronic purchasing unit 16 in real time due to human error.

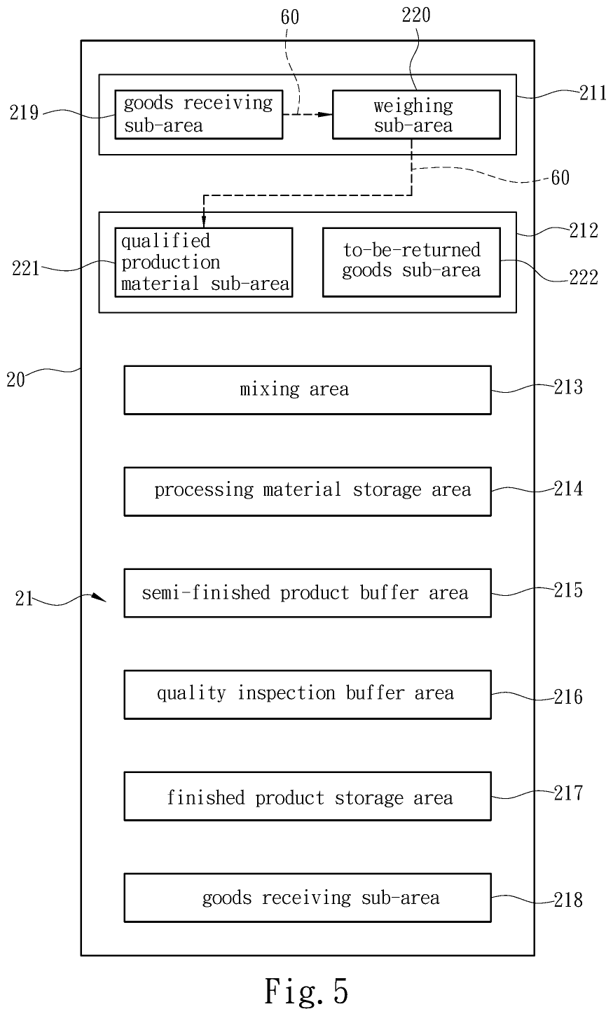

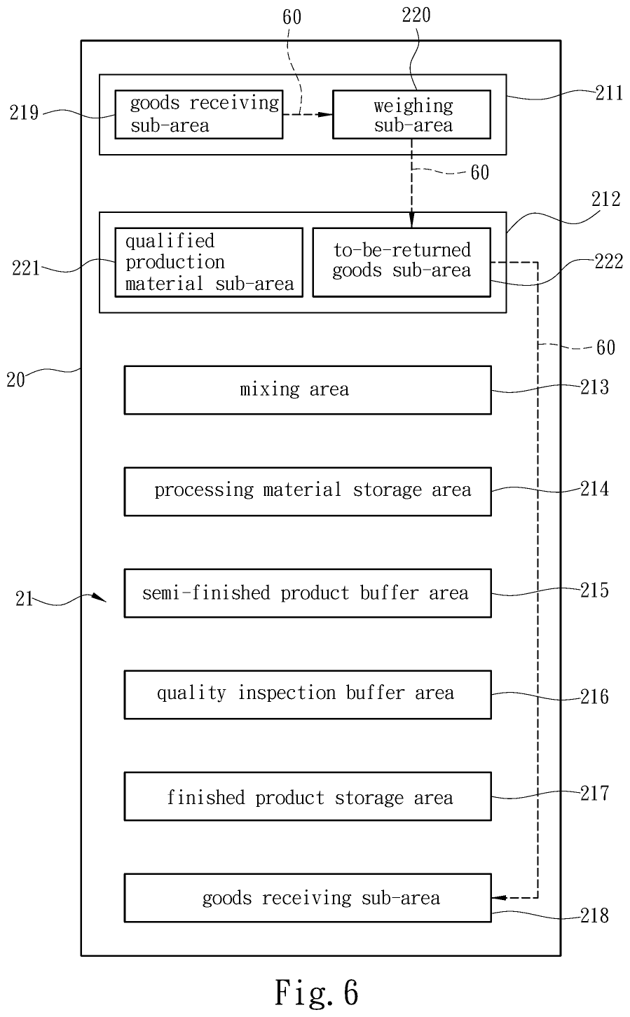

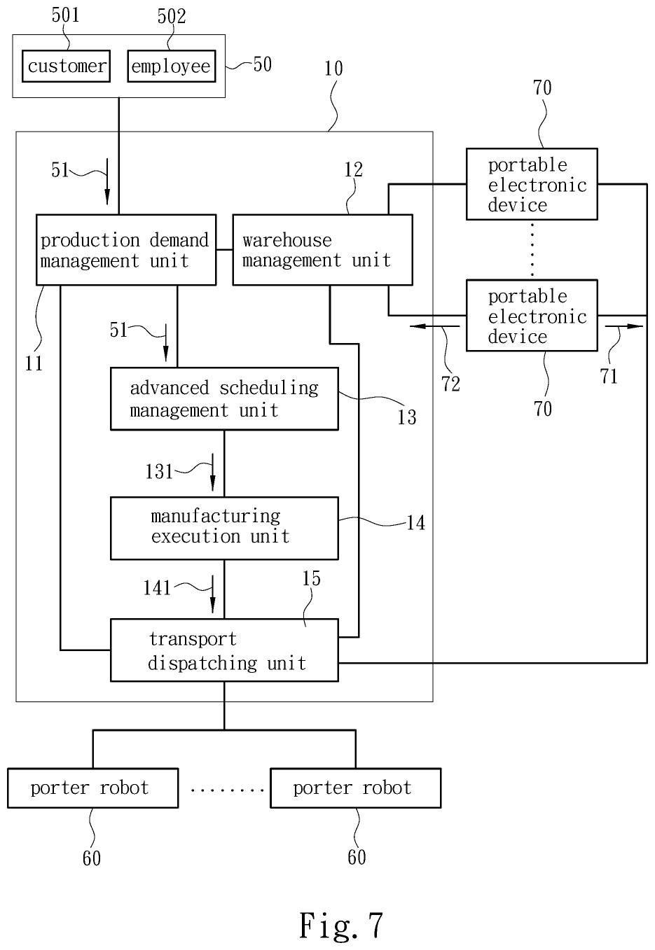

Accordingly, with reference to FIG. 4, FIG. 5 and FIG. 6, when the at least one supply end 30 supplies production materials to the factory area 20, the production materials will be first placed in the goods receiving sub-area 219 for inspection by workers after entering the factory. Thereafter, the transport dispatching unit 15 controls the plurality of porter robots 60 to transport the production materials to the weighing sub-area 220 for inspection. Upon inspection, the system 10 determines whether the production materials are correct according to a weight of product materials. When the weight of the production material is correct, the plurality of porter robots 60 will transport the production materials to the qualified production material sub-area 221 for subsequent processing. Also, when the weight of the production materials is not correct, the production demand management unit 11 enables the warehouse management unit 12 updating the storage data of the production materials corresponding to the production materials, and the transport dispatching unit 15 controls the plurality of porter robots 60 to transport the production materials to the to-be-returned goods sub-area 222 when a quality of the production materials fails. When the at least one supply end 30 proposes to retrieve the production materials unqualified, the transport dispatching unit 15 then enables the plurality of porter robots 60 transporting the production materials to the to-be-delivered area 218 for the at least one supply end 30 to pull out. Also, referring to FIG. 7, the transport dispatching unit 15 is connected with a portable electronic device 70 held by a worker. When the production materials are ready to be stored and warehoused after inspection, the worker controls the portable electronic device 70 to send a warehouse-entry transport request 71 to the transport dispatching unit 15; at this time, the transport dispatching unit 15 controls at least one of the plurality of porter robots 60 to transport the production materials to the raw material storage area 212 based on the warehouse-entry transport request 71. Meanwhile, the warehouse management unit 12 updates and adjusts at least one of the plurality of production material storage data based on a warehouse-entry information 72 transmitted by the portable electronic device 70.

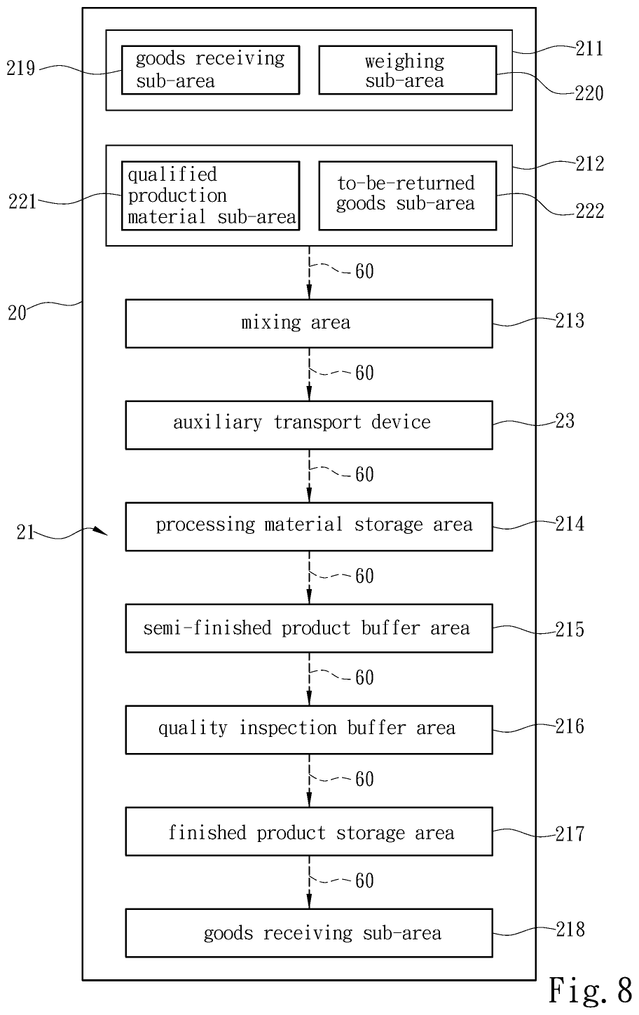

Also, referring to FIG. 8, in an embodiment, since the plurality of porter robots 60 are hindered from moving due to a slope or an obstacle that may be provided in the factory area 20, and the factory area 20 comprises at least one auxiliary transport device 23 connected with the transport dispatching unit 15. In an embodiment, the auxiliary transport device 23 is a lifting device, a conveyor belt or a mechanical arm. In practice, the transport dispatching unit 15 controls the auxiliary transport device 23 according to the transport route of one of the plurality of porter robots 60. In other words, one of the plurality of porter robots 60 gradually approaches an obstacle in the factory area 20 while transporting the production materials, the transport dispatching unit 15 controls the auxiliary transport device 23 to take over the production materials from one of the plurality of porter robots 60 so as to continuously move the production materials. For example, a slope is located in the mixing area 213 and the processing material storage area 214 of the factory area 20 and the lifting device is provided at a position corresponding to the slope, when the plurality of porter robots 60 leave the mixing area 213, the transport dispatching unit 15 controls the lifting device to take over the production materials from the plurality of porter robots 60, thus assisting the plurality of porter robots 60 in transporting the production materials to the processing material buffer area 214.

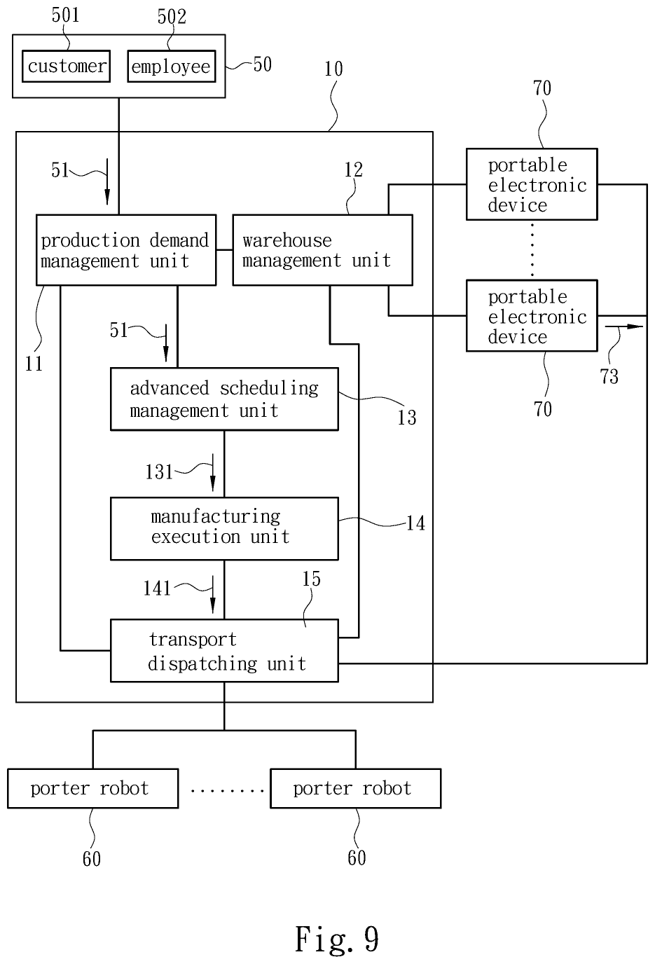

In an embodiment, referring to FIG. 9, the transport dispatching unit 15 not only controls the plurality of porter robots 60 based on each of the plurality of processing data, but also controls at least one of the plurality of porter robots 60 to transport based on a designated transport request 73 sent by the portable electronic device 70. In other words, when the worker of the factory has a demand for transporting the production materials, the worker can operate the portable electronic device 70 to send and transmit the designated transport request 73 to the transport dispatching unit 15; and then, the transport dispatching unit 15 controls at least one of the plurality of porter robots 60 to move to one of the plurality of operation areas 21 which is designated.

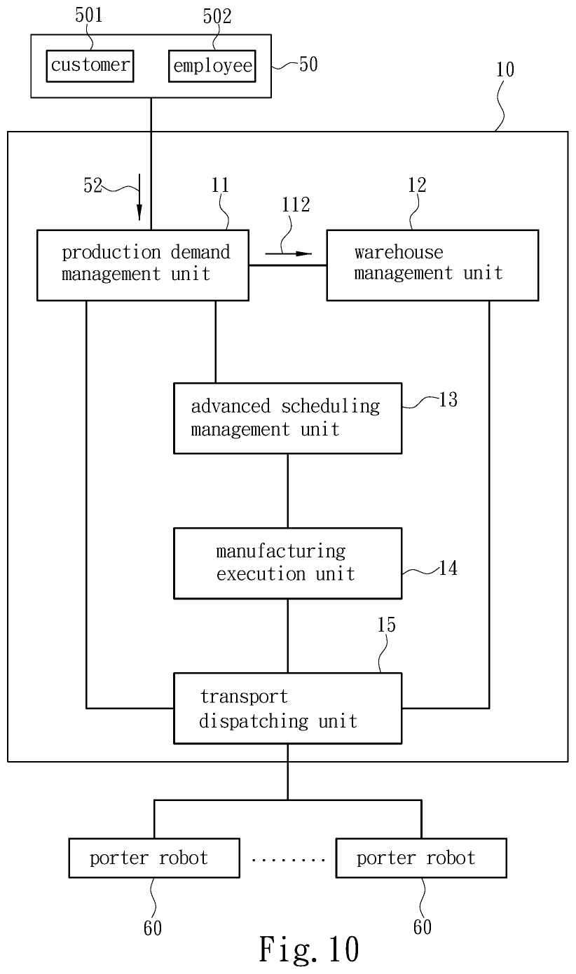

In an embodiment, referring to FIG. 10, when the production demand management unit 11 receives at least one goods delivery data 52 input from an external 50, the system 10 initiates a goods delivery process. First, the external 50 referred to herein is a third person outside the system 10, e.g., the third person is a customer 501 or salesman, etc. When the customer 501, salesman or the like places an order, the production demand management unit 11 receives the at least one goods delivery data 52 and sends a goods-delivery transport notice data 112 to the warehouse management unit 12 based on the goods delivery data 52, and the warehouse management unit 12 requests the transport dispatching unit 15 to control at least one of the plurality of porter robots 60 to move to the finished product storage area 217 according to the goods-delivery transport notice data 112, enabling at least one of the plurality of porter robots 60 to transport the finished product to the to-be-delivered area 218 for goods delivery.

What is claimed is:

1. A system for performing dynamic production and factory area material transportation management, comprising:
a production demand management unit, receiving at least one production demand data input externally;
a warehouse management unit, connected with the production demand management unit, and the warehouse management unit recording a plurality of production material storage data which respectively comprises a name information, a position information and a quantity information;
an advanced scheduling management unit, connected with the production demand management unit, and the advanced scheduling management unit receiving the at least one production demand data and outputting at least one production scheduling data based on the at least one production demand data and working states of a plurality of operation areas in the factory area;
a manufacturing execution unit, connected with the advanced scheduling management unit, and the manufacturing execution unit receiving the at least one production scheduling data and generating at least one production execution data based on the at least one production scheduling data, and the at least one production execution data comprises a plurality of processing data and a plurality of material data respectively corresponding to one of the plurality of processing data; and
a transport dispatching unit, connected with the manufacturing execution unit and the warehouse management unit, and the transport dispatching unit controlling at least one of a plurality of porter robots based on one of the plurality of processing data to transport the production material based on one of the plurality of material data to the one of the operation areas correspondingly, wherein after the one of the processing data is marked, the transport dispatching unit further controls at least one of a plurality of porter robots to transport semi-finished products made by the marked processing data to the next operation area according to another one of a plurality of processing data subsequent to the marked processing data.

2. The system according to claim 1, wherein the system further comprises an electronic purchasing unit connected with the production demand management unit, wherein the production demand management unit generates a purchasing data according to the at least one production demand data and the plurality of production material storage data, and the production demand management unit sends the purchasing data to the electronic purchasing unit to cause the electronic purchasing unit to send a purchasing notice to at least one supply end.

3. The system according to claim 2, wherein the plurality of operation areas comprises a raw material factory-entry inspection area and a raw material storage area, the transport dispatching unit is connected with at least one portable electronic device held by a worker, and the transport dispatching unit controls at least one of the plurality of porter robots to transport raw materials from the raw material factory-entry inspection area based on an warehouse-entry transport request sent by the portable electronic device, and the warehouse management unit updates and adjusts at least one of the plurality of production material storage data based on a warehouse-entry information transmitted by the portable electronic device when the transport dispatching unit controls the at least one of the plurality of porter robots to transport the production materials to the raw material storage area.

4. The system according to claim 3, wherein the raw material factory-entry inspection area comprises a goods receiving sub-area and a weighing sub-area.

5. The system according to claim 3, wherein the production demand management unit receives at least one goods delivery data input externally and sends a goods-delivery transport notice data to the warehouse management unit based on the goods delivery data, and the warehouse management unit requests the transport dispatching unit to control at least one of the plurality of porter robots to move to one of the operation areas where finished products are stored according to the goods-delivery transport notice data.

6. The system according to claim 5, wherein the transport dispatching unit is connected with at least one auxiliary transporting device in the factory area, and the transport dispatching unit controls the auxiliary transporting device according to a transport route of one of the plurality of porter robots.

7. The system according to claim 1, wherein the production demand management unit receives at least one goods delivery data input externally and sends a goods-delivery transport notice data to the warehouse management unit based on the goods delivery data, and the warehouse management unit requests the transport dispatching unit to control at least one of the plurality of porter robots to move to one of the operation areas where the finished products are stored according to the goods-delivery transport notice data.

8. The system according to claim 1, wherein the transport dispatching unit is connected with at least one auxiliary transporting device in the factory area, and the transport dispatching unit controls the auxiliary transporting device according to a transport route of one of the plurality of porter robots.

9. The system according to claim 8, wherein the auxiliary transporting device is selected from the group consisting of a lifting device, a conveyor belt, or a mechanical arm.

10. The system according to claim 1, wherein the transport dispatching unit defines portable areas of the plurality of porter robots based on the plurality of operation areas.

11. The system according to claim 10, wherein the transport dispatching unit records a plurality of location points of the factory area, and the transport dispatching unit controls the plurality of porter robots based on the plurality of location points of the factory area.

12. The system according to claim 11, wherein the transport dispatching unit is connected with at least one portable electronic device held by a worker, and the transport dispatching unit controls at least one of the plurality of porter robots to move r based on a designated transport request sent by the portable electronic device.

13. The system according to claim 12, wherein the plurality of operation areas is a batching area, a machining material buffer area, a semi-finished product buffer area, a quality inspection buffer area, a finished product storage area, and a to-be-delivered area, respectively.

14. The system according to claim 1, wherein the transport dispatching unit is connected with at least one portable electronic device held by a worker, and the transport dispatching unit controls at least one of the plurality of porter robots to move based on a designated transport request sent by the portable electronic device.

15. The system according to claim 14, wherein the plurality of operation areas is a batching area, a machining material buffer area, a semi-finished product buffer area, a quality inspection buffer area, a finished product storage area, and a to-be-delivered area.
